(19) United States
(12) Patent Application Publication
(10) Pub. No.: US 2017/0220033 A1
(43) Pub. Date: Aug. 3, 2017

(54) SYSTEM AND METHOD FOR INTERACTIVE ADJUSTMENT OF A MODEL PREDICTIVE CONTROLLER IN AN EMBEDDED EXECUTION ENVIRONMENT

(71) Applicant: Honeywell International, Inc., Morris Plains, NJ (US)

(72) Inventors: Sriram Hallihole, Bangalore (IN); Ranganathan Srinivasan, Bangalore (IN); Millan Mohapatra, Bangalore (IN); Muslim Gulam Kanji, Orefield, PA (US)

(21) Appl. No.: 15/009,680

(22) Filed: Jan. 28, 2016

(51) Int. Cl. G05B 19/418; G05B 19/042

(52) U.S. Cl. CPC G05B 19/41885; G05B 19/042; G05B 2219/25011

(57) ABSTRACT

A method includes receiving an adjustment to a computational speed of a processing device associated with a model predictive controller (MPC) in an embedded execution platform of an industrial process control system. The method also includes receiving an adjustment to a memory footprint required for calculations performed by the processing device during operation of the MPC. The method further includes loading the MPC in the embedded platform, where the loading includes the adjustments to the computational speed and the memory footprint.

### TECHNICAL FIELD

This disclosure relates generally to industrial process control and automation systems. More specifically, this disclosure relates to a system and method for interactive adjustment of a model predictive controller in an embedded execution environment.

### BACKGROUND

Industrial process control and automation systems are often used to automate large and complex industrial processes. These types of systems routinely include sensors, actuators, and controllers. The controllers typically receive measurements from the sensors and generate control signals for the actuators.

Model predictive controllers (MPCs) (also known as multivariable predictive controllers or multivariable controllers) have long been used in industrial processes to manage complex systems such that the systems operate at limits that are economically beneficial. Due to increasing computational availability in embedded environments, MPCs are now being offered as standard products at the Distributed Control System (DCS) level. Embedded MPC implementations provide a number of advantages, including fault tolerant control, faster execution, easier configuration and maintenance, integrated DCS displays, and better alarming.

### SUMMARY

This disclosure provides a system and method for interactive adjustment of a model predictive controller in an embedded execution environment.

In a first embodiment, a method includes receiving an adjustment to a computational speed of a processing device associated with a model predictive controller (MPC) in an embedded execution platform of an industrial process control system. The method also includes receiving an adjustment to a memory footprint required for calculations performed by the processing device during operation of the MPC. The method further includes loading the MPC in the embedded platform, where the loading includes the adjustments to the computational speed and the memory footprint.

In a second embodiment, an apparatus includes at least one processing device and at least one interface configured to communicate with an MPC in an embedded execution platform of an industrial process control system. The at least one processing device is configured to receive an adjustment to a computational speed of a second processing device associated with the MPC. The at least one processing device is also configured to receive an adjustment to a memory footprint required for calculations performed by the second processing device during operation of the MPC. The at least one processing device is further configured to load the MPC in the embedded platform, where the loading includes the adjustments to the computational speed and the memory footprint.

In a third embodiment, a non-transitory computer readable medium contains instructions that, when executed by at least one processing device, cause the at least one processing device to receive an adjustment to a computational speed of a second processing device associated with an MPC in an embedded execution platform of an industrial process control system. The medium also contains instructions that, when executed by at least one processing device, cause the at least one processing device to receive an adjustment to a memory footprint required for calculations performed by the second processing device during operation of the MPC. The medium further contains instructions that, when executed by at least one processing device, cause the at least one processing device to load the MPC in the embedded platform, where the loading includes the adjustments to the computational speed and the memory footprint.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2A and 2B illustrate example screens of an operator station configured to adjust operation tuning parameters for a model predictive controller (MPC) according to this disclosure;

FIG. 3 illustrates an example framework where an operator can monitor both embedded MPC applications and other WPC applications in a single integrated user environment according to this disclosure;

FIGS. 4 and 5 illustrate example screens from an operator station executing an online process monitoring environment according to this disclosure;

FIG. 6 illustrates an example method for interactive modeling and control of an MPC according to this disclosure; and

FIG. 7 illustrates an example computing device for implementing the methods and teachings according to this disclosure.

### DETAILED DESCRIPTION

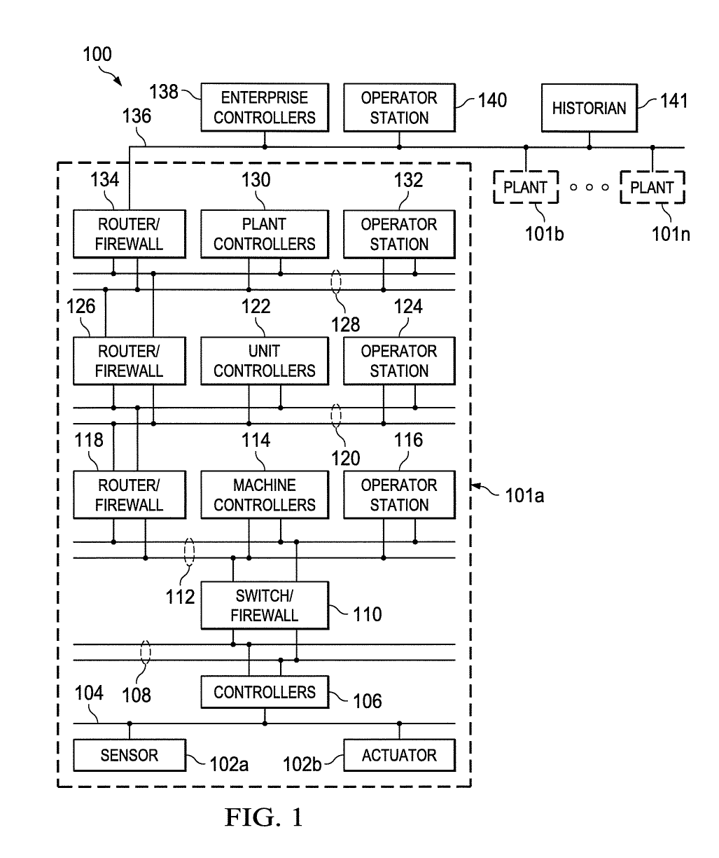

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Additionally or alternatively, each controller 114 could represent a multivariable controller embedded in a Distributed Control System (DCS), such as a RMPCT controller or other type of controller implementing MPC or other APC. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of; or operations related to one or more machines or other pieces of equipment in a process unit. Each of the unit-level controllers 122 could, for example, represent a server computing device running a MICROSOFT WINDOWS operating system. Additionally or alternatively, each controller 122 could represent a multivariable controller, such as a HONEYWELL C300 controller. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (IVIES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). The instructions and data may comprise a software package for use in operating and controlling MPCs, such as PROFIT SUITE by HONEYWELL INTERNATIONAL INC. Each of the controllers and operator stations could also include at least one network interface, such as one or more Ethernet interfaces or wireless transceivers.

In accordance with this disclosure, properties of one or more of the controllers in the system 100 (such as the controllers 106, machine-level controllers 114, or unit-level controllers 122) may be interactively adjusted using an operator station (such as the operator stations 116, 124). For example, a controller's computational speed and memory footprint can be interactively adjusted by a user at an operator station. Additional details regarding this functionality are provided below.

Although FIG. 1 illustrates one example of an industrial process control and automation system 100, various changes may be made to FIG. 1. For example, a control system could include any number of sensors, actuators, controllers, servers, operator stations, networks, and safety managers. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, while FIG. 1 illustrates one example environment in which a controller's computational speed and memory footprint can be interactively adjusted, this functionality can be used in any other suitable device or system.

MPCs have long been used in industrial process control and automation systems, such as the system 100, to manage complex systems so that the systems operate at limits that are economically beneficial. Due to increasing computational availability in embedded environments, MPCs are now being offered as standard products embedded at the DCS level. Typical MPCs have a large number of inputs and outputs, each of which may need to operate within certain limits. Small changes to one input or output can have a significant impact to one or more other inputs or outputs. To optimize the complete set of inputs and outputs, various mathematical models can be used, such as quadratic/linear programming (QP/LP) computational models.

Some embedded environments limit MPC implementations in various ways. For example, large allocations of computational or storage memory may be required to handle future predictions and previous states, which may be more memory than is allocated for a particular controller. As another example, depending on processing speeds and capabilities, a long computing time may be required to solve steady state economic problems and dynamic limit optimization control move problems associated with controller optimization.

Most implementations for industrial systems allow some leeway in the embedded design to address the limitations described above. For example, some implementations reduce the number of manipulated variables to a small number or only implement very few control strategies in a single controller (or other hardware component) of a DCS. Essentially, these implementations take a conservative approach and over-design the system to ensure that the controller works as intended.

Even when care is taken to design a conservative environment, a controller may violate one or both of the above-mentioned limitations during run-time (or when online). For example, a solver (such as a computational engine associated with one or more embedded or connected processors of a controller) may take too long to execute due to current process conditions, thereby inducing controller cycle over-runs. As another example, the required memory may exceed the designed limit due to plant model changes. When such violations occur, a typical solution is to unload the controller, re-design the controller configuration or hardware, and load the controller again into the embedded environment. However, controller re-design and validation in an offline simulation environment is a time consuming activity and may become an iterative process.

To address these issues, embodiments of this disclosure provide configurable operation parameters that can be changed online to comply with dynamic memory footprint and computational speed requirements of an MPC in an embedded environment. One such operation parameter allows configuration of a memory footprint for an existing controller, such as at the time the controller is loaded into an embedded environment. Another operation parameter enables a change in the QP/LP solver or other computational speed, such as by allowing changes in a maximum number of QP/LP solver iterations from a predetermined benchmark value for the particular controller problem size.

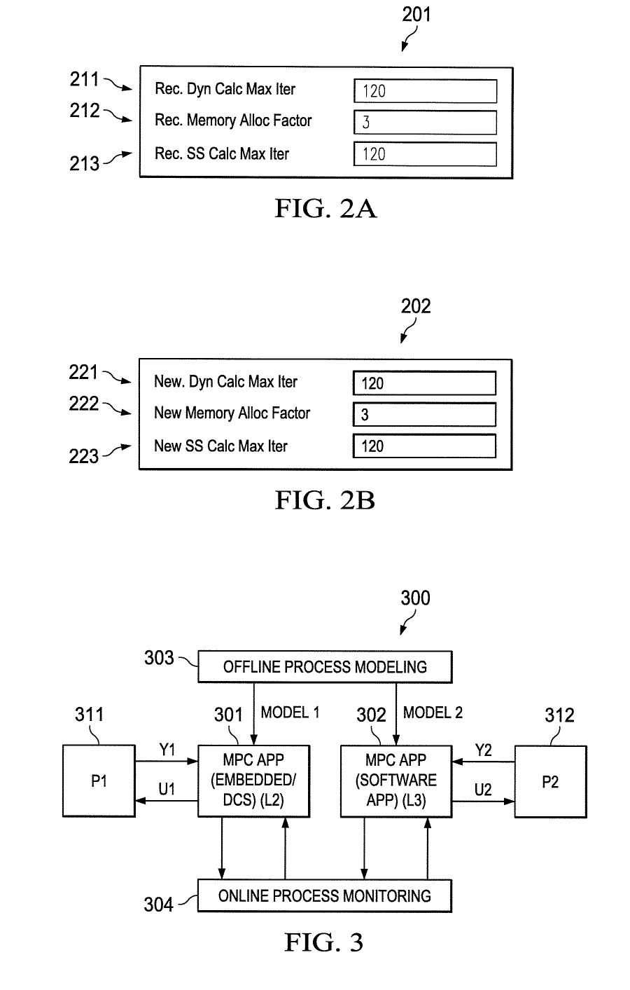

FIGS. 2A and 2B illustrate example screens 201-202 of an operator station configured to adjust operation tuning parameters for an MPC according to this disclosure. The screens 201-202 are associated with a controller or control system operator station application, such as PROFIT SUITE OPERATOR STATION by HONEYWELL INTERNATIONAL INC. The software application may be executed at an operator station in an industrial process control and automation system, such as the operator stations 116, 124. Note, however, that the screens 201-202 may be associated with other suitable controller software.

The screen 201 shows predetermined recommended values 211-213 for three tuning parameters associated with operation of an MPC, such as one of the controllers 106, machine controllers 114, or unit controllers 122. The value 211 denotes a recommended value for a maximum number of iterations to be performed for dynamic control calculations in the QP/LP solver or other solver. Dynamic control calculations are associated with a relatively short time horizon and may represent a next move or operation in a calculation process. The value 212 denotes a recommended value for the memory allocation factor, which represents a scaling factor or multiplier for the required memory footprint. As used here, a memory footprint represents an amount of memory required for calculations performed by the QP/LP solver or other solver during operation of the MPC. For example, if x bytes of memory are recommended for the calculations performed by the QP/LP solver, a memory allocation factor of three would allocate 3x bytes of memory for use by the calculations. The value 213 denotes a recommended value for a maximum number of iterations to be performed for steady state calculations in the QP/LP solver or other solver. Steady state calculations are associated with a relatively longer time horizon than the dynamic control calculations.

In some embodiments, each of the recommended values 211-213 may be determined empirically and may reflect an optimal value in a typical implementation of the MPC. In particular embodiments, the recommended values 211-213 can be informational and may not be adjustable by an operator. Instead, the recommended values 211-213 could provide the operator with a guideline for determining values to use in interactively configuring the controller tuning parameters.

The screen 202 shows editable fields in which the operator can provide new values 221-223 for controller tuning parameters. The values 221-223 can be updated before execution of a run-time environment. In some embodiments, once execution starts, the values 221-223 are not able to be updated during execution of the run-time environment.

In the screen 202, the operator (such as a process engineer) can enter new values 221-223 for the tuning parameters. In some embodiments, the values 221-223 may default to the pre-calculated recommended values 211-213, and the operator can modify the values 221-223 in any suitable manner, such as based on a current need to change the computational time or the memory allocation as appropriate. In particular embodiments, the operator can select new values 221-223 that are within a predetermined range relative to the recommended values 211-213. For example, each new value 221-223 may be up to 20% less than or greater than the corresponding recommended value 211-213. In other embodiments, there may be only an upper limit, only a lower limit, or no limit on each new value 221-223.

Although FIGS. 2A and 2B illustrate examples of screens of an operator station configured to adjust operation tuning parameters for an MPC, various changes may be made to FIGS. 2A and 2B. For example, the screens 201-202 could be formatted differently and could include any number of tuning parameters.

As described above, the hardware resource requirements for an MPC can vary based on the type of process being controlled. This variation in hardware requirements can become a limitation for controlling a variety of processes. Using the adjustable operation tuning parameters shown in FIGS. 2A and 2B, an operator does not have to model the process each time a change is needed. Instead, the operator can vary the parameters interactively to achieve the same objective.

Depending on the hardware and software platform, some MPC applications are executed in an embedded controller platform, while other MPC applications are executed as a software application in a different hardware platform. For example, some Level 2 controllers include one or more MPC applications embedded and executed in the controller hardware. In contrast, some Level 3 controllers may be associated with one or more MPC applications that are executed as software applications in a different hardware platform. In some conventional control systems that include different types of controllers (such as both Level 2 and Level 3 controllers), it may be necessary or desirable to have different operator stations to monitor and control the different types of controllers. This can result in added costs for hardware, software, and personnel.

Embodiments of this disclosure address the problem of having different kinds of visualizations and process parameters for monitoring and controlling processes using multiple types of MPCs. The disclosed embodiments provide an integrated user environment where an operator can monitor all types of MPC applications in one place, irrespective of whether each MPC application is running in a physical process control network or in a hardware platform where the MPC application is running online. The operator can choose to run the MPC applications either in the embedded platform or as a software application in a different hardware platform. Here, the configuration, tuning, and monitoring parameters between different MPC types can be the same. Because of this, it is possible to model each process independent of where the process is being pushed to for online execution. Once an offline process model is created, the operator can push the model to various types of MPC controllers.

FIG. 3 illustrates an example framework 300 where an operator can monitor both embedded MPC applications and other MPC applications in a single integrated user environment according to this disclosure. The framework 300 may be used in conjunction with controllers in an industrial process control and automation system, such as the system 100. The framework 300 may also be used in any other suitable system.

As shown in FIG. 3, the framework 300 includes two MPC applications 301-302 running in different hardware platforms. In this example, the MPC application 301 could denote an MPC application for a Level 2 controller embedded in a DCS platform, and the MPC application 302 could denote an MPC application for a Level 3 controller that executes as software running on a different hardware platform from the controller itself (such as a non-embedded platform).

Each MPC application 301-302 is connected to a physical process in an industrial process control and automation system, such as a cooling unit or a high-pressure process. In this example, the MPC application 301 is connected to a physical process (P1) 311. The MPC application 301 inputs setpoint targets (U1) to the physical process 311 and receives measurements (Y1) that are output from the physical process 311. Similarly, the MPC application 302 is connected to a physical process (P2) 312, and the MPC application 302 inputs set point targets (U2) to the physical process 312 and receives measurements (Y2) that are output from the physical process 312. In some embodiments, the physical processes 311-312 represent different processes. In other embodiments, the physical processes 311-312 may be the same physical process that is associated with multiple MPCs.

The framework 300 also includes an offline process modeling environment 303 and an online process monitoring environment 304. The offline process modeling environment 303 represents an environment in which process inputs, outputs, and other process parameters can be modeled, optimized, and validated outside of the run-time platform. Unlike conventional process modeling environments that are specifically tied to a particular hardware platform, the offline process modeling environment 303 provides a common environment for monitoring, controlling, and tuning parameters across different MPC applications that are running in either an embedded environment or as software applications in a different control network. In some embodiments, the offline process modeling environment 303 may represent the PROFIT SUITE ENGINEERING STUDIO (PSES) from HONEYWELL INTERNATIONAL INC. Using the offline process modeling environment 303, a user of the framework 300 can choose either an embedded MPC or any other MPC based on the user's current objective.

The offline process modeling environment 303 can indicate whether a particular MPC application is in compliance with an embedded platform's hardware resource limitations (and can therefore be hosted in the embedded platform for online execution) or whether the MPC application should be hosted in another hardware platform. The offline process modeling environment 303 can include some or all of the tuning parameters 211-213, 221-223 of FIGS. 2A and 2B. Using the tuning parameters 211-213, 221-223 in the offline process modeling environment 303, a user can adjust the memory requirements and processing requirements for a particular MPC application. This allows, for example, the user to tune an MPC engine so that it meets MPC application memory and CPU requirements.

After a model is validated using the offline process modeling environment 303, a user can choose the correct platform based on the hardware resource requirements and push the model for online execution. For example, as shown in FIG. 3, the user can choose to push Model 1 to the embedded platform associated with the MPC application 301 and push Model 2 to the non-embedded platform associated with the MPC application 302.

The online process monitoring environment 304 allows a user to monitor and manage functions and parameters associated with MPCs executing in a run-time environment. The online process monitoring environment 304 is configured for monitoring MPCs executing in different platforms. For example, both MPCs applications 301-302 are communicatively connected to the online process monitoring environment 304. In some embodiments, the online process monitoring environment 304 may represent the PROFIT SUITE OPERATOR STATION (PSOS) from HONEYWELL INTERNATIONAL INC.

Although FIG. 3 illustrates one example of a framework 300 where an operator can monitor both embedded MPC applications and other MPC applications in a single integrated user environment, various changes may be made to FIG. 3. For example, the framework 300 may include other controllers or components in other environments.

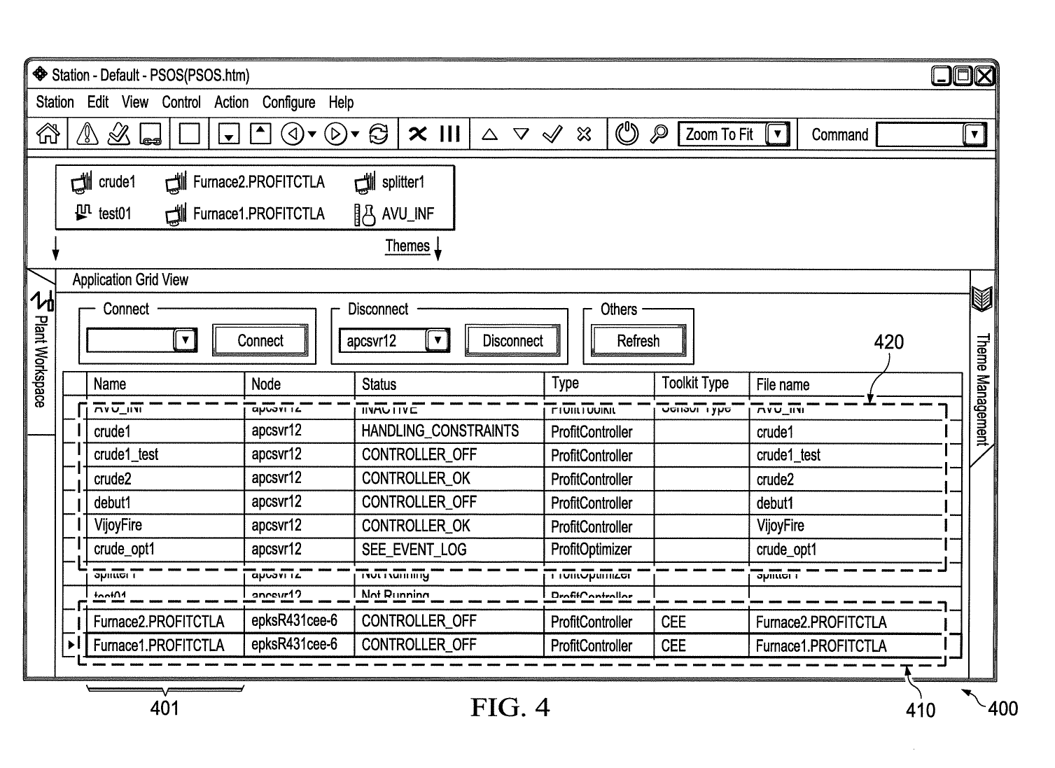

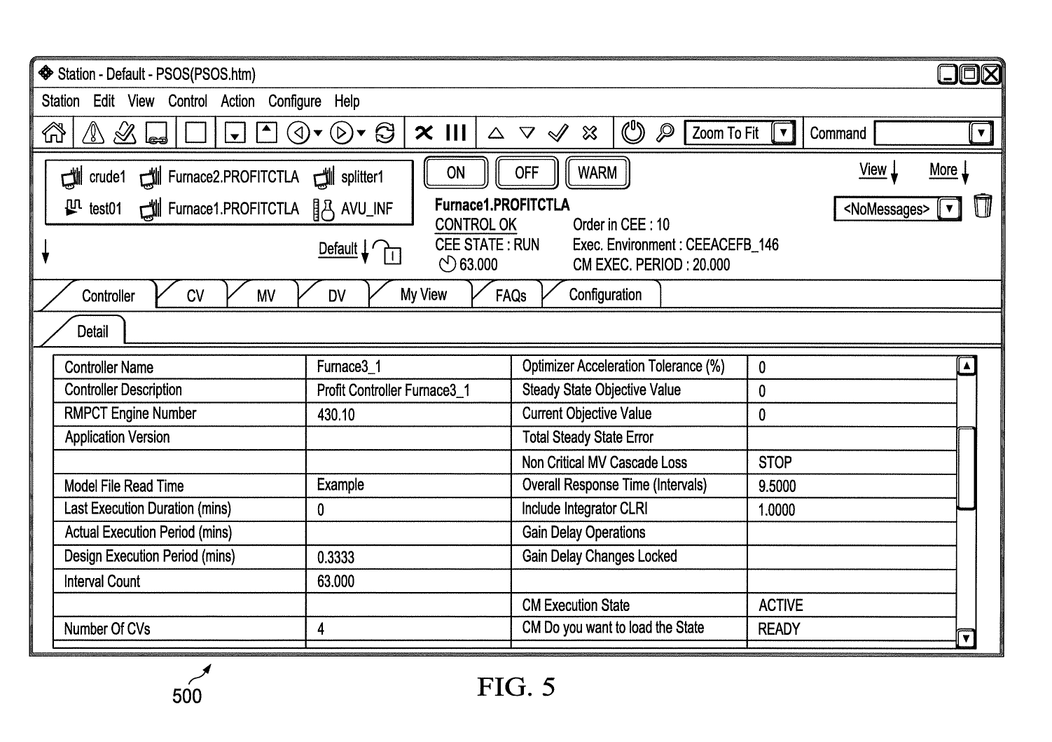

FIGS. 4 and 5 illustrate example screens from an operator station executing an online process monitoring environment according to this disclosure. The online process monitoring environment could denote the online process monitoring environment 304 according to this disclosure. The screen 400 in FIG. 4 displays summary information of MPCs running in different platforms. A column 401 of the screen 400 shows the names or identifiers of the MPCs that the operator has access to in the operator station application. The two MPC applications shown in box 410 are running in an embedded platform, like the MPC application 301. The other MPC applications shown in box 420 are running as software applications, like the MPC application 302.

The screen 500 in FIG. 5 shows additional details of a particular controller selected from the list of controllers in FIG. 4. For example, in FIG. 4, the row for controller ‘Furnace1.PROFITCTLA’ is highlighted. In FIG. 5, additional details for the controller ‘Furnace1.PROFITCTLA’ are displayed. Using the operator station application shown in screens 400, 500, a plant operator or system engineer can monitor different processes in a single integrated visualization, regardless of which platform the actual MPC is running in.

Although FIGS. 4 and 5 illustrate examples of screens from an operator station executing an online process monitoring environment, various changes may be made to FIGS. 4 and 5. For example, the screens 400, 500 could be formatted differently and could display other types of information.

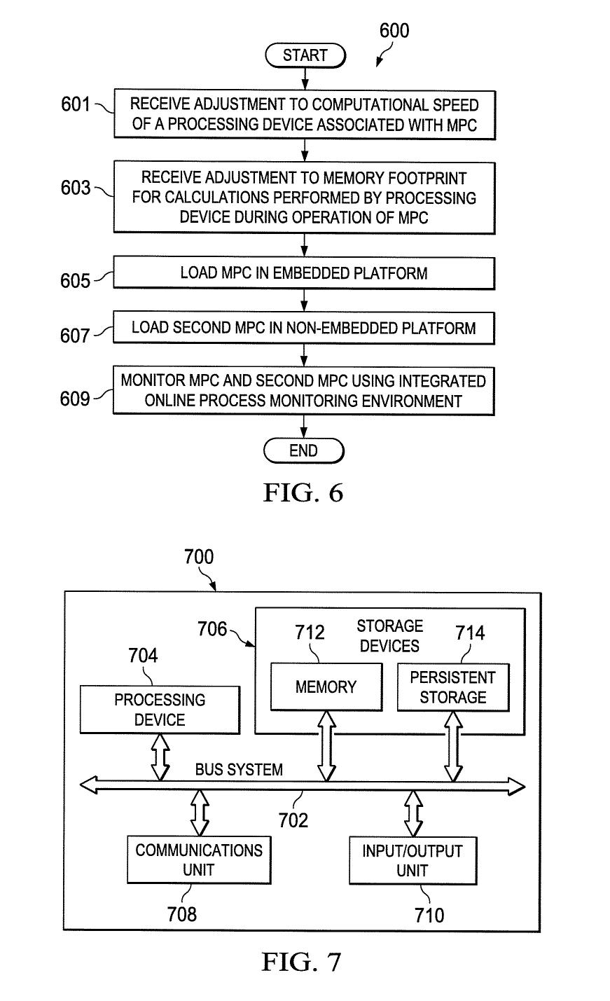

FIG. 6 illustrates an example method 600 for interactive modeling and control of an MPC according to this disclosure. For ease of explanation, the method 600 is described as being performed using the framework 300 of FIG. 3. However, the method 600 could be used with any suitable device or system.

At step 601, the framework 300 receives an adjustment to a computational speed of a processing device associated with an MPC in an embedded execution platform of an industrial process control system. This may include, for example, a user of an offline process modeling environment inputting the adjustment in a display field. The adjustment to the computational speed of the processing device can include an adjustment to a maximum number of iterations to be performed by the processing device for dynamic control calculations. Additionally or alternatively, the adjustment to the computational speed of the processing device can include an adjustment to a maximum number of iterations to be performed by the processing device for steady state calculations. At step 603, the framework 300 receives an adjustment to a memory footprint required for calculations performed by the processing device during operation of the MPC. This may include, for example, the user of the offline process modeling environment inputting the adjustment in a display field. At step 605, the MPC is loaded in the embedded platform. The loading of the MPC includes the adjustments to the computational speed and the memory footprint.

At step 607, a second MPC is loaded in a non-embedded platform. In some embodiments, the non-embedded platform is a platform in which the second MPC and an associated MPC application execute on different hardware. In particular embodiments, the loading of the MPC and the second MPC is performed using a single integrated offline process modeling environment that is configured to load the same process model to either an embedded platform or a non-embedded platform, such as the offline process modeling environment 303. At step 609, the MPC and the second MPC are monitored using a single integrated online process monitoring environment. The online process monitoring environment can be configured to allow a user to monitor MPCs executing in run-time in both an embedded platform and a non-embedded platform, such as the online process monitoring environment 304.

Although FIG. 6 illustrates one example of a method 600 for interactive modeling and control of an MPC, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs. In addition, while the method 600 and the framework 300 are described with respect to MPCs in an industrial process control system, the method 600 and framework 300 may be used in conjunction with other types of devices and systems.

FIG. 7 illustrates an example computing device 700 for implementing the methods and teachings according to this disclosure. The device 700 could, for example, represent any of the controllers, operator stations, and computing devices described above. Note, however, that other implementations of the controllers, operator stations, and computing devices could also be used.

As shown in FIG. 7, the device 700 includes a bus system 702, which supports communication between at least one processing device 704, at least one storage device 706, at least one communications unit 708, and at least one input/output (I/O) unit 710. The processing device 704 executes instructions that may be loaded into a memory 712. The processing device 704 may include any suitable number(s) and type(s) of processors or other devices in any suitable arrangement. Example types of processing devices 704 include microprocessors, microcontrollers, digital signal processors, field programmable gate arrays, application specific integrated circuits, and discrete circuitry.

The memory 712 and a persistent storage 714 are examples of storage devices 706, which represent any structure(s) capable of storing and facilitating retrieval of information (such as data, program code, and/or other suitable information on a temporary or permanent basis). The memory 712 may represent a random access memory or any other suitable volatile or non-volatile storage device(s). The persistent storage 714 may contain one or more components or devices supporting longer-term storage of data, such as a ready only memory, hard drive, Flash memory, or optical disc.

The communications unit 708 supports communications with other systems or devices. For example, the communications unit 708 could include a network interface card that facilitates communications over at least one Ethernet or serial connection. The communications unit 708 could also include a wireless transceiver facilitating communications over at least one wireless network. The communications unit 708 may support communications through any suitable physical or wireless communication link(s).

The I/O unit 710 allows for input and output of data. For example, the I/O unit 710 may provide a connection for user input through a keyboard, mouse, keypad, touchscreen, or other suitable input device. The I/O unit 710 may also send output to a display, printer, or other suitable output device.

Although FIG. 7 illustrates one example of a computing device 700, various changes may be made to FIG. 7. For example, various components in FIG. 7 could be combined, further subdivided, or omitted and additional components could be added according to particular needs. Also, computing devices can come in a wide variety of configurations, and FIG. 7 does not limit this disclosure to any particular configuration of computing device.

The embodiments of this disclosure are suitable for use with multiple products and services from HONEYWELL INTERNATIONAL INC. Example products include the PROFIT SUITE R440 and EXPERION R440 products. Of course, the disclosed embodiments can be used in conjunction with other products and services, including those by other companies.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving an adjustment to a computational speed of a processing device associated with a model predictive controller (MPC) in an embedded execution platform of an industrial process control system;
receiving an adjustment to a memory footprint required for calculations performed by the processing device during operation of the MPC; and
loading the MPC in the embedded platform, wherein the loading includes the adjustments to the computational speed and the memory footprint.

2. The method of claim 1, wherein the adjustment to the computational speed of the processing device comprises at least one of:
an adjustment to a maximum number of iterations to be performed by the processing device for dynamic control calculations; and
an adjustment to a maximum number of iterations to be performed by the processing device for steady state calculations.

3. The method of claim 1, wherein the adjustments to the computational speed and the memory footprint are received from an offline process modeling environment.

4. The method of claim 3, wherein:
the MPC is a first MPC;
the method further comprises loading a second MPC in a non-embedded platform;
the loading of the first MPC and the loading of the second MPC are performed using the offline process modeling environment, and
the offline process modeling environment is a single integrated environment configured to load a same process model to either the embedded platform or the non-embedded platform.

5. The method of claim 4, wherein:
the first MPC loaded in the embedded platform is a Level 2 MPC; and
the second MPC loaded in the non-embedded platform is a Level 3 MPC.

6. The method of claim 4, further comprising:
providing a single integrated online process monitoring environment configured to allow a user to monitor MPCs executing in run-time in both the embedded platform and the non-embedded platform.

7. The method of claim 6, further comprising:
displaying, in a display associated with the online process monitoring environment, a list of MPCs including the first and second MPCs.

8. An apparatus comprising:
at least one interface configured to communicate with a model predictive controller (MPC) in an embedded execution platform of an industrial process control system; and
at least one processing device configured to:
receive an adjustment to a computational speed of a second processing device associated with the MPC;
receive an adjustment to a memory footprint required for calculations performed by the second processing device during operation of the MPC; and
load the MPC in the embedded platform, wherein the loading includes the adjustments to the computational speed and the memory footprint.

9. The apparatus of claim 8, wherein the adjustment to the computational speed of the second processing device comprises at least one of:
an adjustment to a maximum number of iterations to be performed by the processing device for dynamic control calculations; and
an adjustment to a maximum number of iterations to be performed by the processing device for steady state calculations.

10. The apparatus of claim 8, wherein the at least one processing device is configured to receive the adjustments to the computational speed and the memory footprint from an offline process modeling environment.

11. The apparatus of claim 10, wherein:
the MPC is a first MPC;
the at least one processing device is further configured to load a second MPC in a non-embedded platform;
the offline process modeling environment is configured to facilitate the loading of the first MPC and the loading of the second MPC; and
the offline process modeling environment is a single integrated environment configured to load a same process model to either the embedded platform or the non-embedded platform.

12. The apparatus of claim 11, wherein:
the first MPC loaded in the embedded platform is a Level 2 MPC; and
the second MPC loaded in the non-embedded platform is a Level 3 MPC.

13. The apparatus of claim 11, wherein the at least one processing device is further configured to provide a single integrated online process monitoring environment configured to allow a user to monitor MPCs executing in run-time in both the embedded platform and the non-embedded platform.

14. The apparatus of claim 13, wherein the at least one processing device is further configured to control a display associated with the online process monitoring environment to display a list of MPCs including the first and second MPCs.

15. A non-transitory computer readable medium containing instructions that, when executed by at least one processing device, cause the at least one processing device to:
receive an adjustment to a computational speed of a second processing device associated with a model predictive controller (MPC) in an embedded execution platform of an industrial process control system;
receive an adjustment to a memory footprint required for calculations performed by the second processing device during operation of the MPC; and
load the MPC in the embedded platform, wherein the loading includes the adjustments to the computational speed and the memory footprint.

16. The non-transitory computer readable medium of claim 15, wherein the adjustment to the computational speed of the second processing device comprises at least one of:
an adjustment to a maximum number of iterations to be performed by the processing device for dynamic control calculations; and
an adjustment to a maximum number of iterations to be performed by the processing device for steady state calculations.

17. The non-transitory computer readable medium of claim 15, wherein the instructions when executed cause the at least one processing device to receive the adjustments to the computational speed and the memory footprint from an offline process modeling environment.

18. The non-transitory computer readable medium of claim 17, wherein:
the MPC is a first MPC;
the medium further contains instructions that, when executed by the at least one processing device, cause the at least one processing device to load a second MPC in a non-embedded platform;
the offline process modeling environment is configured to facilitate the loading of the first MPC and the loading of the second MPC; and
the offline process modeling environment is a single integrated environment configured to load a same process model to either the embedded platform or the non-embedded platform.

19. The non-transitory computer readable medium of claim 18, wherein the medium further contains instructions that, when executed by the at least one processing device, cause the at least one processing device to:
provide a single integrated online process monitoring environment configured to allow a user to monitor MPCs executing in run-time in both the embedded platform and the non-embedded platform.

20. The non-transitory computer readable medium of claim 19, wherein the medium further contains instructions that, when executed by the at least one processing device, cause the at least one processing device to:
control a display associated with the online process monitoring environment to display a list of MPCs including the first and second MPCs.
